(19) United States
(12) Patent Application Publication
(10) Pub. No.: US 2008/0103871 A1
(43) Pub. Date: May 1, 2008

(54) Company project management system

(75) Inventors: Michael Ruehl, Tucson, AZ (US); Harlan Mickelson, Tucson, AZ (US); Daniel Curtis, Tucson, AZ (US); Jackson Lacy, Tucson, AZ (US)

Correspondence Address: Benman, Brown & Williams, 2049 Century Park East, Suite 2740, Los Angeles, CA, 90067, US

(73) Assignee: Raytheon Company

(21) Appl. No.: 11/977,870

(22) Filed: Oct. 26, 2007

Related U.S. Application Data
(60) Provisional application No. 60/854,911, filed on Oct. 26, 2006.

(51) Int. Cl. G06Q 10/00; G06F 17/30; G06F 17/40

(52) U.S. Cl. 705/9

(57) ABSTRACT

A company project management system. The novel system includes a database server for providing multiple users with access to a project file, which includes a schedule for a project with a plurality of tasks and task dependencies, and a statusing system for concurrently obtaining performance updates from multiple users and updating the schedule in the project file with the performance updates in real time as the performance updates are obtained. In a preferred embodiment, the statusing system is adapted to control when tasks can be updated based on task dependencies such that updating for a task with dependencies is disabled unless the dependencies have been fulfilled. The statusing system may also include a tool for allowing a user to add a plurality of sub-tasks to a parent task and enter performance updates for the sub-tasks. The statusing system automatically updates the parent task based on the updates obtained for the sub-tasks.

### CROSS-REFERENCE TO RELATED APPLICATIONS

This application claims the benefit of U.S. Provisional Application No. 60/854,911, filed Oct. 26, 2006, the disclosure of which is hereby incorporated by reference.

### BACKGROUND OF THE INVENTION

1. Field of The Invention

The present invention relates to project management systems. More specifically, the present invention relates to project management software.

2. Description of the Related Art

Project management refers to the managing of resources (e.g., people) in order to successfully complete a project comprised of a plurality of different tasks. Several project management software products, such as Microsoft Project, are available to assist with this process. In general, project managers input the tasks necessary for the completion of a project into the software along with information about each task such as task dependencies, resources required, and estimated time for completing the task. The software then generates a schedule for the project. As the project is executed, project managers can update the performance status of the tasks, inputting information such as actual start and finish dates and percentage of completion of each task. The project management software can then be used to generate reports on the progress of the project and to reanalyze the schedule, computing a new estimated time to project completion and possibly reallocating resources in order to meet deadlines.

With conventional project management software, it can be very labor intensive and time consuming to capture schedule performance data on large projects (e.g., over 10,000 tasks). Traditionally, manual means have been used to capture and enter this critical performance information, whereby copies of the project schedule were distributed and collected, and input often required repeated attempts due to the lack of real time feedback and communication across teams and project leaders. It has also been difficult to share access and updates to a large program schedule.

Storage of the project files on a discreet computer typically forces singular access to the data. In addition, frequent statusing and modifications force the data to be taken offline to be processed. This significantly increases the effort to maintain the data, as well as making it non-accessible to those who may need it.

Hence, a need exists in the art for an improved system or method for capturing schedule performance data on large projects that is less labor intensive and less time consuming than conventional approaches.

### SUMMARY OF THE INVENTION

The need in the art is addressed by the project management system of the present invention. The novel system includes a database server for providing multiple users with access to a project file, which includes a schedule for a project with a plurality of tasks and task dependencies, and a statusing system for concurrently obtaining performance updates from multiple users and updating the schedule in the project file with the performance updates in real time as the performance updates are obtained. In a preferred embodiment, the statusing system is adapted to control when tasks can be updated based on task dependencies such that updating for a task with dependencies is disabled unless the dependencies have been fulfilled. The statusing system may also include a tool for allowing a user to add a plurality of sub-tasks to a parent task and enter performance updates for the sub-tasks. The statusing system automatically updates the parent task based on the updates obtained for the sub-tasks. In an illustrative embodiment, the novel project management system also includes a client application adapted to interface with a stand-alone project management software, providing a plurality of analysis tools for assisting in the creation and maintenance of the schedule data in accordance with predefined business rules and a tool for automatically uploading a project file to the database.

### BRIEF DESCRIPTION OF THE DRAWINGS

FIG. 1 is a simplified block diagram of a company project management system designed in accordance with an illustrative embodiment of the present invention.

FIG. 2 is a simplified flow diagram showing the operation of a company project management system designed in accordance with an illustrative embodiment of the present invention.

FIG. 3 is a simplified flow diagram of a statusing application designed in accordance with an illustrative embodiment of the present invention.

FIG. 4 is a screenshot of a sample project selection display designed in accordance with an illustrative embodiment of the present invention.

FIG. 5 is a screenshot of a sample task detail screen designed in accordance with an illustrative embodiment of the present invention.

FIG. 6 is a screenshot of a sample task detail screen with inchstones designed in accordance with an illustrative embodiment of the present invention.

### DESCRIPTION OF THE INVENTION

Illustrative embodiments and exemplary applications will now be described with reference to the accompanying drawings to disclose the advantageous teachings of the present invention.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

The company project management system of the present teachings includes a novel schedule development and implementation tool that allows multiple users to concurrently access and status project files using predefined company business rules. In an illustrative embodiment, project schedules are created by project managers using a stand-alone project management software product (such as Microsoft Project) and then stored in a shared program schedule database for performance updates by task leaders. A novel statusing application provides real time controlled web access directly into the shared database, allowing concurrent access to the program data with real time schedule update feedback between teams and project leaders. Business rules are implemented in the system to ensure data integrity and automated communication means.

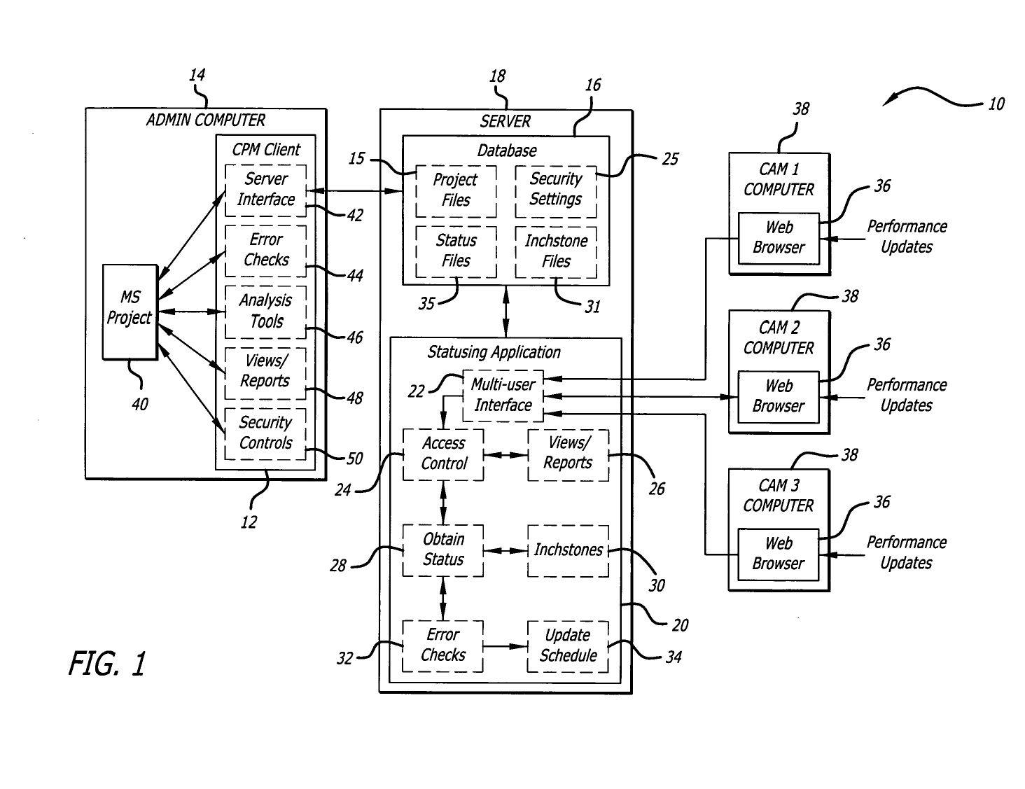

FIG. 1 is a simplified block diagram of a company project management system 10 designed in accordance with an illustrative embodiment of the present invention. The system 10 is used by two distinct user groups: administrators, who are typically project management experts that are able to create and maintain master planning schedules using Microsoft (MS) Project or other similar software, and cost account managers (CAMs) or other task leaders who are responsible for ensuring their assigned tasks are current and do not violate any established business rules. As shown in FIG. 1, the company project management system 10 includes two parts: a client application 12 running on a computer 14, which allows a project administrator to store project files 15 in a SQL database 16 on a server 18, and a statusing application 20 running on the server 18, which allows multiple CAMs to concurrently access and update the project files 15 stored in the database 16.

In an illustrative embodiment, the statusing application 20 uses a web interface 22 that communicates with users through web browsers 36 on their individual computers 38. The web status application 20 provides a web-based interface 22 that is more user friendly than MS Project and allows multiple users to access and update the project file 15 simultaneously. The statusing application 20 also provides the CAMs with the structure needed to maintain the integrity of the schedule. To this end, the statusing application 20 includes an access control sub-routine 24 that controls which users can access which projects and tasks based on security settings 25 stored in the database 16. In accordance with the present teachings, the access control sub-routine 24 also controls when tasks can be updated based on their task dependencies (tasks cannot be statused or updated unless their dependencies have been fulfilled).

The statusing application 20 also includes a statusing sub-routine 28 for obtaining performance updates on tasks from the users and an error checking sub-routine 32 for checking the performance data for errors, ensuring that the data complies with preset company business rules. After the performance data has been received and checked for errors, an update sub-routine 34 incorporates the data into the schedule, updating the schedule and saving it in the project file 15. In a preferred embodiment, the performance data is also saved separately in status files 35 that are also stored in the database 16 and can be downloaded by the project administrator. Once the updated data is stored to the project file, it is immediately available to other users. The statusing application 20 may also includes a plurality of views and reports 26 for displaying the schedule data in the project file 15.

In a preferred embodiment, the statusing application 20 also includes an “inchstones” sub-routine 30 that allows a user to add sub-tasks to a task without adding to the project file 15 by saving the sub-tasks in separate inchstone files 31 that are linked to the original project file 15. In this embodiment, the statusing sub-routine 28 is configured to obtain performance updates on the sub-tasks and automatically update the parent task based on the sub-task updates.

In an illustrative embodiment, the client application 12 includes a server interface 42 for automatically uploading project files from MS Project 40 to the database 16 and downloading project files 15 and/or status files 35 from the database 16. The client application 12 may also include error checking tools 44 for ensuring that a schedule complies with preset company business rules before uploading a file 15 to the database 16 or after incorporating status updates into the schedule, analysis tools 46 that can be used in MS Project 40 to help create and maintain the schedule, standardized views or reports 48 for displaying the schedule data, and security controls 50 for setting the security settings 25 that control the user privileges for accessing or updating files in the database 16.

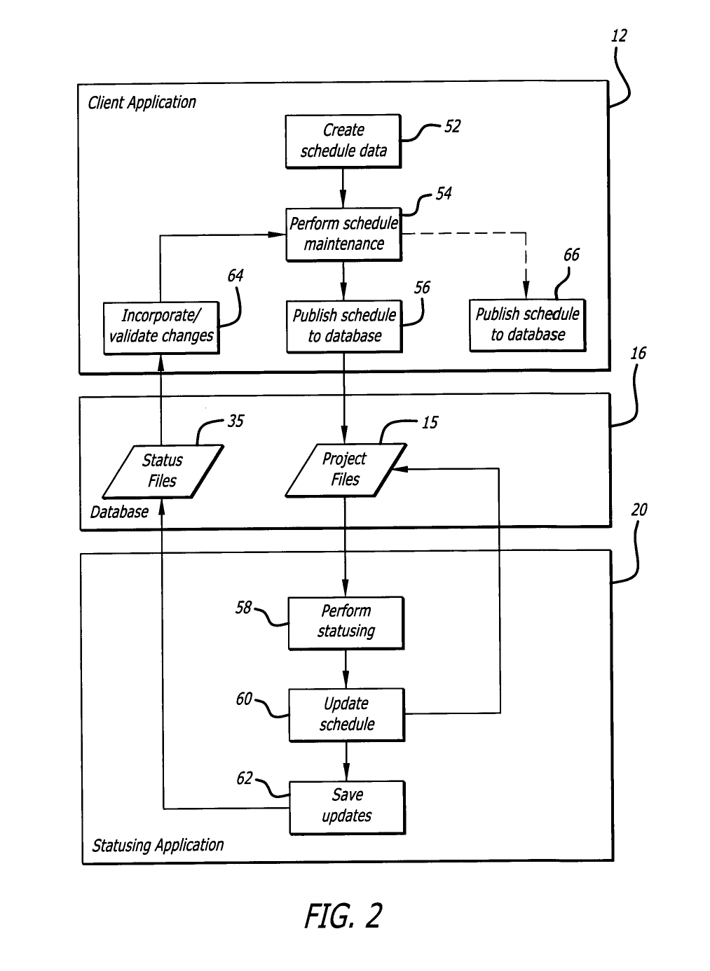

FIG. 2 is a simplified flow diagram showing the operation of a company project management system 10 designed in accordance with an illustrative embodiment of the present invention. First, at Step 52, a project administrator creates a project schedule using the client application 20 in conjunction with software such as MS Project. In an illustrative embodiment, the client application 12 works within MS Project, providing additional analysis tools based on company business rules (these tools may be accessible from within MS Project through, for example, additional buttons in the toolbar or through the MS Project menu). The project administrator inputs a list of tasks necessary for the completion of the project and information about each task such as task dependencies, resources required, and estimated time for completing the task. MS Project 30 then generates a schedule for the project and saves it in a project file on the administrator's computer 14.

At Step 54, after the schedule is initially created, and also periodically after status updates, the administrator performs analyses and maintenance on the schedule using MS Project and the additional tools provided by the client application 12 to analyze and validate the schedule data. For example, this may include verifying that task dependencies and task constraints are correct, verifying that the correct resources are applied, verifying costs and task durations, etc. The project administrator can then make changes to the schedule to correct for potential problems and to optimize the schedule.

In a preferred embodiment, the client application 12 includes several analysis tools that are accessible from within MS Project for helping the administrator maintain the schedule. In an illustrative embodiment, the client application 12 includes a settings tool that automatically sets the settings in MS Project to predetermined values, allowing the schedule to behave more predictably and allowing it to be standardized across the company. The application 12 may also include standardized views, charts, and reports, which may be stored in the database 16 so that everyone in the company is using the same views, charts, and reports.

In a preferred embodiment, the client application 12 includes a “wellness” tool that analyzes the schedule for critical issues and best practice scheduling techniques defined by the company. The wellness tool searches the schedule and identifies potential issues (defined by company business practices). For example, the wellness tool may search for tasks with undesirable constraints (such as must start/finish on or before a particular date), tasks without predecessors or successors, tasks missing documentation data, tasks with zero or negative slack, tasks that have not started despite having predecessors that are 100% complete, etc. The wellness tool then displays a list of the issues, the number of tasks with each issue, and the percentage of tasks in the project that do not have each issue. The wellness tool also allows the administrator to filter the schedule to show the tasks that have been identified as having a particular issue, so the problem can be corrected if desired.

The client application 12 may also include a tool for identifying tasks at risk, such as tasks that are a certain number (user defined number) of days behind or a certain percentage behind, or otherwise not performing according to the schedule.

The client application 12 may also include tools for helping the user to more easily navigate through a large schedule. For example, the application 12 may include a tool for automatically displaying a selected task's predecessors and successors. The client application 12 may also include a tool for calculating and displaying the critical path to a selected task.

After the project administrator has validated the schedule and made any desired changes, the client application 12 provides a pre-status check that can be run before the project file is pushed to the database 16 for statusing. The pre-status check ensures that the schedule is ready to be statused by checking for logic errors in the schedule and also checking that the correct earned value methods are being applied. For example, the pre-status check may search for tasks in which the percentage of completion is at 100% but the earned value is less than 100%, or tasks where the percentage of completion is at 0% but the earned value is greater than 0%, or tasks in which the earned value technique (such as 50/50 or 0/100) has not been defined.

Returning to FIG. 2, after the schedule is ready for statusing, at Step 56, the client application 12 publishes the project file 15 to the database 16. The client application 12 may also include security controls for allowing the administrator to set up access privileges within the database 16 and statusing application 20. The security settings determine which project files each user can access, which tasks in a file each user can update, and if the user is allowed to create or update inchstones.

Once the project file 15 is stored in the database 16, it is ready for statusing by the CAMs and task leaders. At Step 58, the CAMs log in to the statusing application 20 and enter their performance data for that reporting period (including, for example, actual start or finish dates on tasks, percentage of completion, extended duration if the task is estimated to take longer than originally planned, etc.). In accordance with the present teachings, the statusing application 20 is designed to allow multiple users to access and update the same project file at the same time.

The statusing application 20 controls which users can access which files, and which tasks in a file each user is allowed to update, based on the security settings described above. In addition, the statusing application 20 also controls when tasks can be updated based on the task dependencies defined in the project file. For example, a task with a “finish-to-start” dependency cannot be statused until its predecessor task is completed, and a task with a “start-to-start” dependency cannot be statused unless its predecessor task has started. Once a CAM has updated a predecessor task, indicating that a dependency requirement has been fulfilled (e.g., the task has been completed or started), statusing for the successor task is immediately enabled. If the CAM of the successor task is also using the statusing application 20, he can then enter his performance data for the successor task. Thus, by controlling the order in which tasks can be statused based on their task dependencies, multiple users can update the project in real time without any schedule conflicts.

In a preferred embodiment, the statusing application 20 also performs error checking on the performance data to ensure they comply with predefined business rules. For example, verifying that the actual start or finish dates entered are not on non-working days, verifying that start/finish dates comply with task constraints (such as start no earlier than a specified date), and verifying that the data is in compliance with task dependencies (for example, the start date cannot be earlier than the finish date of a finish-to-start predecessor).

After a user inputs performance updates, at Step 60, the statusing application 20 updates the schedule with the new performance data and saves the updated schedule in the project file 15. Performance updates are saved to the project file immediately after they are input by the user, so that other users who are accessing the file can immediately see the new changes, in real time. If the performance updates affects other tasks, these changes are shown in the updated schedule. For example, if a CAM extends a task by 20 days, then the scheduled start date of a successor task will be pushed back by 20 days. These changes to the schedule are immediately available to other users of the statusing application 20.

In a preferred embodiment, at Step 62, the performance updates reported by the CAMs in the statusing application 20 are also saved into separate status files 35 (which may be, for example, text files) in addition to being incorporated into the project file 15 in the database 16. This allows for the statused data to be verified before it is included in the master schedule on the project administrator's computer. The project administrator can therefore download the already statused project file 15 from the database 16 or the separate status files 35, which are validated and then incorporated into the master schedule.

In the preferred embodiment, at the end of the statusing period after the CAMs have completed statusing their tasks, at Step 64, the project administrator downloads the status files 35 from the database 16, validates the performance updates, and incorporates them into the master schedule. In an illustrative embodiment, the client application 12 also includes a post-status check tool that checks the schedule after statusing to verify that it does not contain any logic errors.

The cycle then repeats, returning to schedule maintenance at Step 54. The statusing cycle may be repeated periodically, such as monthly or weekly, or on an as needed basis. If desired, at Step 66, the schedule may be published to the database 16 for reporting, or to other programs for additional analysis.

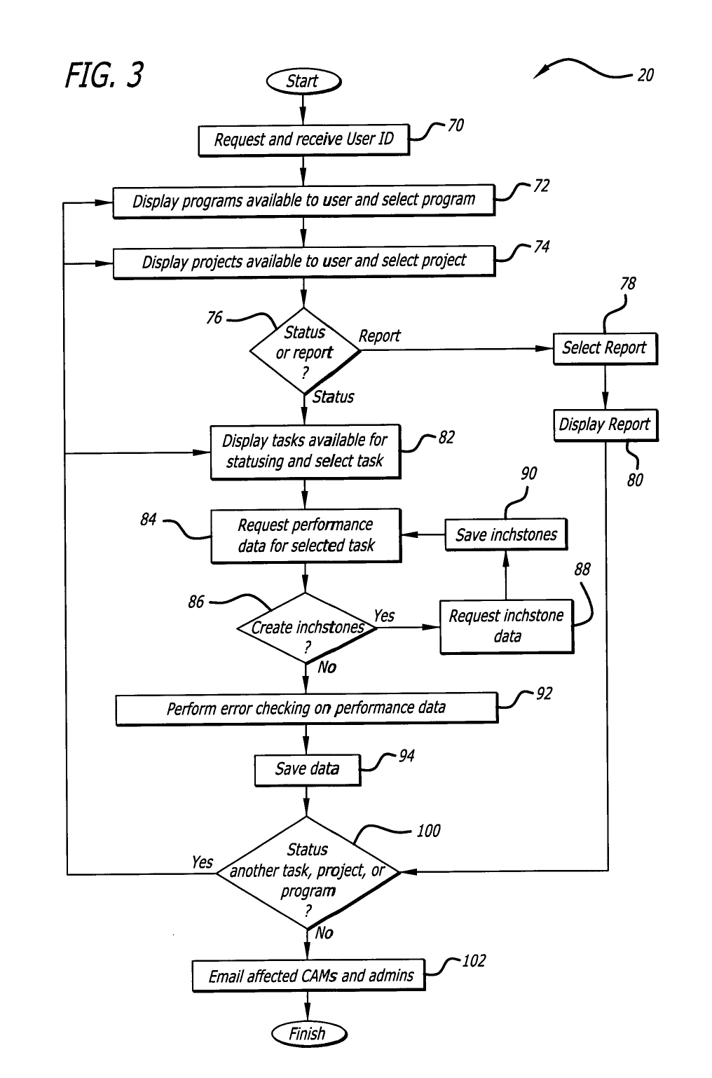

FIG. 3 is a simplified flow diagram of a statusing application 20 designed in accordance with an illustrative embodiment of the present invention. First, at Step 70, the web status application 20 displays a login window, requesting a user ID and password. After the user has entered his user ID and correct password, at Step 72, the statusing application 20 displays a list of the programs which are available to that particular user based on the security settings previously set by the project administrator, and the user selects which program he wants to work on (in the illustrative embodiment, the projects in the company are grouped into programs or departments).

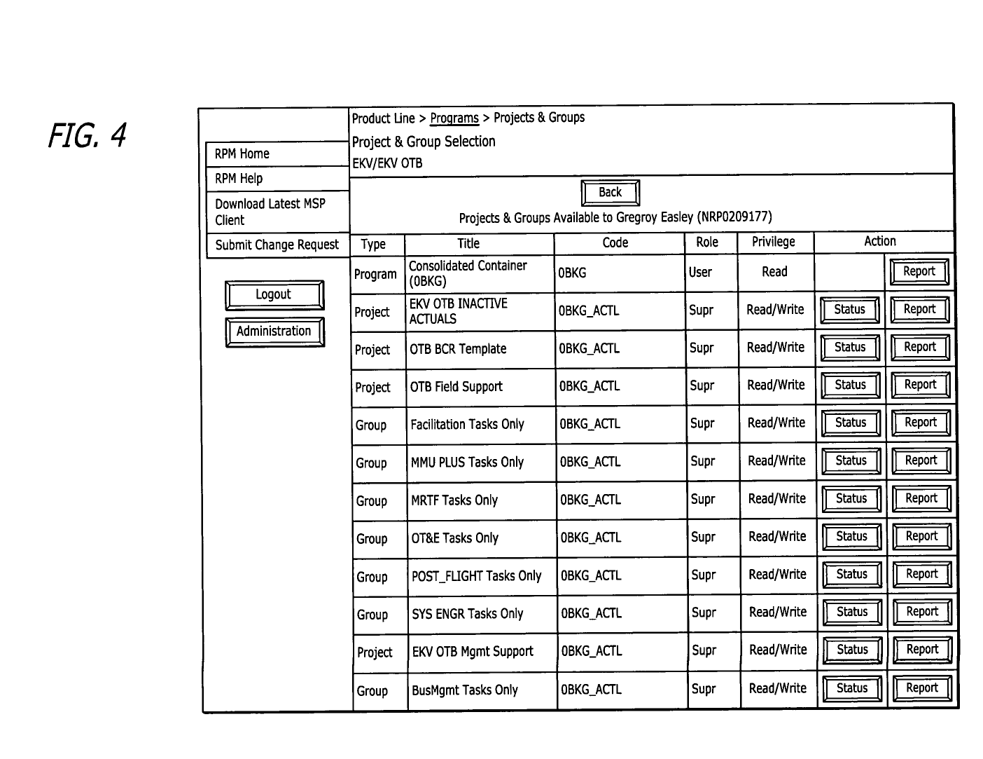

At Step 74, the statusing application 20 displays a list of projects in the selected program that are available to the user (again based on the security settings). The user can choose to either status or run a report on a particular project. In a preferred embodiment, the display also indicates which projects have tasks that need to be updated. This may be indicated through the color of a “status” button next to each project. For example, a blue “status” button could indicate that statusing is complete for that project while a red button could indicate that statusing has not been completed yet. FIG. 4 is a screenshot of a sample project selection display designed in accordance with an illustrative embodiment of the present invention.

At Step 76, the user selects which project he would like to status or run a report on. If he chooses to run a report on a project, at Step 78, the statusing application 20 displays a list of reports the user can choose from and the user selects the desired report. At Step 80, the statusing application 20 accesses the project file for the selected project stored in the database 16 and displays the selected report. At Step 100, the user can then choose to select another project or program.

Returning to Step 76, if the user chooses to status a project, at Step 82, the statusing application 20 accesses the project file for the selected project stored in the database 16 and displays a list of tasks in the selected project which can be statused by the user (as determined by the security settings). The display may indicate which tasks have already completed statusing, which tasks are available for statusing, and which tasks are not yet available for statusing (e.g., tasks with predecessors that are not complete cannot be statused).

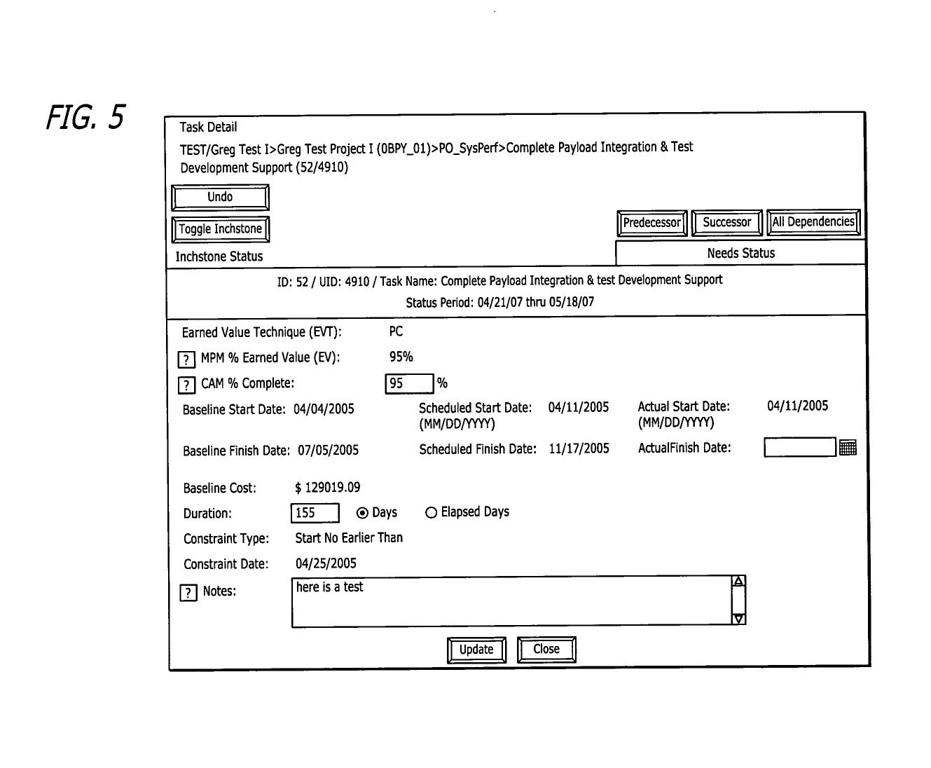

After the user selects a task for statusing, at Step 84, the statusing application 20 displays a task detail screen that includes data on the task (such as baseline start and finish dates, scheduled start and finish dates, and actual start date if this was entered during a previous status period) and blank fields where the user can enter performance data such as actual start and finish dates, percentage of completion, and extended duration. FIG. 5 is a screenshot of a sample task detail screen designed in accordance with an illustrative embodiment of the present invention.

If inchstones are enabled for that particular user and task (as determined by the security settings), the task detail screen may also include a button allowing the user to create inchstones.

In accordance with the present teachings, the statusing application 20 allows a user to divide a task into multiple sub-tasks called “inchstones” that are saved in a separate file that is linked to the original project file. A CAM may want to add more detail to a particular task, especially for tasks with longer durations, to help determine the progress on that task. For example, instead of trying to estimate the percentage of completion of a long task, a CAM may divide the task into 100 sub-tasks. The percentage of completion can then be more easily and more accurately determined (for example, if 20 of 100 equally weighted sub-tasks are completed, then the task is 20% complete). The project administrator, however, may not want to add these sub-tasks to the project file (due to increased complexity or customer reporting requirements or various other reasons). The inchstones capability of the present invention allows the CAM to add sub-tasks to a task and save it in a separate file so that the original project file is unchanged. The statusing application 20 allows the CAM to status the sub-tasks in the inchstone file and automatically updates the performance data (e.g., percentage of completion, actual start/finish dates) of the parent task in the original project file based on the performance data entered for the inchstone sub-tasks.

Returning to FIG. 3, at Step 86, if the user chooses to create inchstones for the selected task, at Step 88, the statusing application 20 displays an inchstone screen where the user can enter a list of inchstones (sub-tasks) comprising the parent task and the percentage weight of each inchstone. Then, at Step 90, the statusing application 20 saves the inchstones in a separate file that is linked to the original project file, and returns to the task detail screen (Step 84).

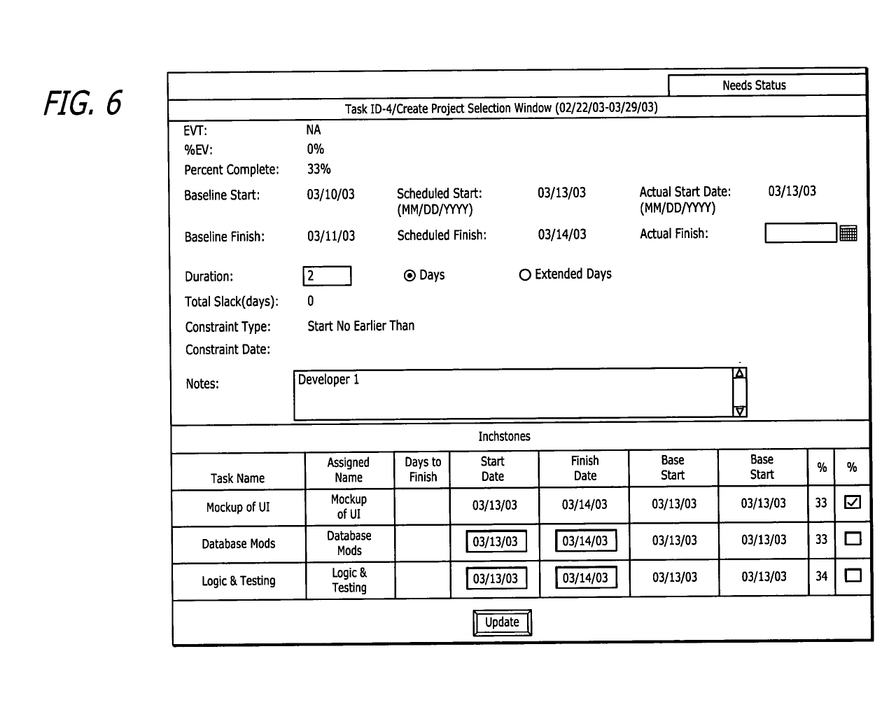

If inchstones have been created for a particular task, the inchstone sub-tasks are displayed on the task detail screen in addition to the data on the parent task. When statusing the task, instead of allowing the user to directly enter the percentage of completion and actual start/finish dates of the parent task, the task detail screen with inchstones includes blank fields in the inchstone section where the user can enter performance data on each inchstone sub-task such as actual start and finish dates and if the inchstone sub-task is complete. The statusing application 20 then automatically calculates the percentage of completion of the parent task and enters the actual start and/or finish dates of the parent task. FIG. 6 is a screenshot of a sample task detail screen with inchstones designed in accordance with an illustrative embodiment of the present invention. After the user has completed entering the performance data for the selected task, whether using inchstones or not, at Step 92, the statusing application performs error checking on the data to ensure they comply with certain business rules (e.g., constraint dates, dependencies). At Step 94, the schedule is updated with the performance data and the results are saved in the project file, where they are immediately available to other users of the statusing application 20. As described above, the performance data may also be saved in a separate text file for validation by the project administrator.

At Step 100, the user can choose to select another task, project, or program. If the user is finished, then at Step 102, the statusing application 20 automatically notifies others affected by the user's updates via email. For example, if the user's performance updates to a particular task indicate that a successor task will have to start later than was scheduled, the CAM for the successor task and the project administrator of the file are emailed with the details of the changes.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

Accordingly,

What is claimed is:

1. A project management system comprising:
first means for providing multiple users with access to a project file, said project file including a schedule for a project with a plurality of tasks and task dependencies, and
second means for concurrently obtaining performance updates from said users and updating said schedule in said file with said performance updates in real time as said performance updates are obtained.

2. The invention of claim 1 wherein said system further includes means for controlling when tasks can be updated based on task dependencies.

3. The invention of claim 2 wherein updating for a task with one or more dependencies is disabled unless said dependencies have been fulfilled.

4. The invention of claim 1 wherein said system further includes means for checking said performance updates for compliance with predefined business rules before updating said schedule with said updates.

5. The invention of claim 1 wherein said system further includes means for adding a plurality of sub-tasks to a parent task and saving said sub-tasks in a file separate from said project file.

6. The invention of claim 5 wherein said system includes means for obtaining performance updates on said sub-tasks.

7. The invention of claim 6 wherein said system includes means for automatically updating said parent task based on performance updates obtained on said sub-tasks.

8. The invention of claim 1 wherein said performance updates include actual start date, actual finish date, and/or percentage of completion of a task.

9. The invention of claim 1 wherein said system includes means for saving said performance updates in a file separate from said project file.

10. The invention of claim 1 wherein said system includes means for automatically notifying users whose tasks are affected by said performance updates due to task dependencies.

11. The invention of claim 1 wherein said second means includes a web interface for communicating with said users.

12. The invention of claim 1 wherein said first means includes a database server.

13. The invention of claim 12 wherein said system further includes a client application on a client computer for automatically uploading said project file from said client computer to said server.

14. The invention of claim 13 wherein said client application is adapted to interface with a stand-alone project management software and provide a plurality of analysis tools for creating and maintaining said schedule in said project management software.

15. The invention of claim 14 wherein said analysis tools includes a tool adapted to search said schedule for potential issues based on predefined business rules.

16. The invention of claim 14 wherein said analysis tools includes a tool for automatically checking for logic errors in said schedule prior to uploading said file to said database.

17. The invention of claim 14 wherein said analysis tools includes a tool for automatically checking for logic errors in said schedule after said performance updates are incorporated into said schedule.

18. The invention of claim 14 wherein said analysis tools includes a tool for automatically setting one or more settings in said stand-alone project management software to predetermined values.

19. The invention of claim 14 wherein said analysis tools includes a tool for automatically identifying tasks at risk.

20. The invention of claim 14 wherein said analysis tools includes a tool for automatically calculating and displaying one or more critical paths to a selected task.

21. The invention of claim 14 wherein said analysis tools includes a tool for navigating through said schedule.

22. A computer readable program for statusing a project schedule comprising:
a first code for interfacing with a plurality of remote users;
a second code for accessing a project file selected by a user, said project file including a schedule for a project with a plurality of tasks and task dependencies;
a third code for obtaining performance updates on different tasks from said users and updating said schedule with said performance updates; and
a fourth code for controlling when tasks can be updated based on their task dependencies.

23. A project management system comprising:
a database server for storing a project file, said project file including a schedule for a project with a plurality of tasks and task dependencies, and
a statusing system adapted to interface with a plurality of remote users to obtain performance updates on different tasks and update said schedule in said project file with said performance updates in real time as said performance updates are obtained.

24. The invention of claim 23 wherein said system further includes a client application on a client computer for automatically uploading said project file from said client computer to said server.

25. The invention of claim 24 wherein said client application is adapted to interface with a stand-alone project management software and provide a plurality of analysis tools for creating and maintaining said schedule.

26. A method for obtaining performance data for a project schedule including the steps of:
storing a project file in a database, said file including a schedule for a project with a plurality of tasks and task dependencies;
interfacing with a plurality of remote users to concurrently obtain performance updates on different tasks;
updating said project file with said performance updates in real time as said updates are obtained; and
controlling when tasks can be updated based on their task dependencies.
